(19) United States
(12) Patent Application Publication
(10) Pub. No.: US 2025/0369061 A1
(43) Pub. Date: Dec. 4, 2025

(54) DIRECT REDUCTION SYSTEM AND METHOD TO MITIGATE THE DISINTEGRATION OF IRON OXIDE DURING A REDUCTION REACTION

(71) Applicant: Midrex Technologies, Inc., Charlotte, NC (US)

(72) Inventors: Haruyasu Michishita, Charlotte, NC (US); Kentaro Urata, Charlotte, NC (US)

(21) Appl. No.: 18/922,940

(22) Filed: Oct. 22, 2024

Related U.S. Application Data
(60) Provisional application No. 63/652,918, filed on May 29, 2024.

(51) Int. Cl. C21B 13/02; C21B 13/00

(52) U.S. Cl. CPC C21B 13/02; C21B 13/0073; C21B 2100/22; C21B 2100/26; C21B 2100/44; C21B 2100/66

(57) ABSTRACT

A direct reduction plant, system, and/or method utilizing gas that is injected between a reduction gas injection level and a top gas offtake level in a shaft furnace to modulate (or moderate) the reduction speed and temperature in the upper portion of the shaft furnace, above the reduction gas injection level, where the initial reduction of iron oxide from Fe2O3 to Fe3O4 or FeO takes place. This gas injected above the reduction gas injection level in the shaft furnace may be quenched process gas, quenched reformed gas, quenched mixed gas (including both quenched process gas and quenched reformed gas), and/or cold process gas. The length of the shaft furnace can also be extended to offset the initial slower reduction or enlarged overall reduction zone so that the productivity can be maintained.

### CROSS-REFERENCE TO RELATED APPLICATION

The present disclosure claims the benefit of priority of co-pending U.S. Provisional Patent Application No. 63/652,918, filed on May 29, 2024, and entitled “DIRECT REDUCTION SYSTEM AND METHOD TO MITIGATE THE DISINTEGRATION OF IRON OXIDE DURING A REDUCTION REACTION,” the contents of which are incorporated in full by reference.

### TECHNICAL FIELD

The present disclosure relates generally to the direct reduced iron (DRI) production and steelmaking fields. More specifically, the present disclosure relates to a direct reduction (DR) system and method to mitigate the disintegration of iron oxide during a reduction reaction.

### BACKGROUND

A DR shaft furnace (SF) normally processes indurated oxide pellets, mostly DR grade oxide pellets containing higher iron content such as Fe content >67 weight %. One of the advantages of DR grade oxide pellets is higher reduction strength, or the tendency for less disintegration during the reduction reaction in the SF. This is because the higher mechanical strength of the indurated oxide pellet is achieved by an iron sintering mechanism as well as a liquidous slag bonding through the induration process at the iron oxide pelletizing plant. Also, higher iron content in the DR grade oxide pellet provides more iron sintering to help recover the physical strength through the reduction reaction at the DR plant. To the contrary, more fines tend to be generated during the reduction process in the SF with lower iron content when blast furnace (BF) grade or lower grade oxide pellets are processed. Lump ores also generate more fines since they do not undergo an induration process.

Furthermore, the cold agglomerates of iron oxides, such as cold bonded briquettes (CBQs), have recently drawn attention due to less CO2 emission by eliminating the induration process, but tend to disintegrate in the SF like the lump ore since the conventional binder cannot keep bonding strength under the initial reduction temperature of 400˜700° C.

Too much fine generation causes serious problems in operating the SF since it reduces the permeability of the burden to make a non-uniform reduction gas flow profile and/or hinders smooth mass flow in the SF. Therefore, in general, conventional DR technologies have faced operation difficulties with the disintegration of various raw materials other than DR grade pellets. Accordingly, the development of a technology to mitigate the disintegration of iron oxide during the DR process in a SF is needed and is essential when DR plants are forced to use various raw materials due to increasing iron oxide demand as more DR plants are built under global CO2 pressure and DR grade iron oxide sources are depleted.

### SUMMARY

Embodiments of the present disclosure improve upon prior systems and methods to reduce the iron oxide in a SF utilizing natural gas (NG) and/or hydrogen (H2) and mitigate the disintegration of the iron oxide during the reduction reaction in the SF.

The swelling and initial reduction speed from Fe2O3 to Fe3O4 or FeO, which influences the disintegration of the iron oxide during the reduction reaction in the SF, is restrained by modulating (or moderating) the temperature and/or quality of the reduction gas flowing through the iron oxide bed in the upper section of the SF. More specifically, this is achieved by injecting the various cold gases above the main reduction gas injection, so that the temperature and/or gas quality profile can be flexibly changed in the upper section in the SF. Simultaneously, as an option, the length of the reduction zone, defined as the distance between the reduction gas port and the controlled feed stock line, can be extended by 1˜3 m for the SF with the invention. The extension will be made to the length of the reduction zone for the conventional SF, typically 9˜13 m depending on the diameter. The summary of the disclosure is provided in the following.

In some embodiments (Case A—FIG. 2), quenched process gas 20 is injected between the reduction gas 14 injection level and the top gas 4 offtake level to modulate the reduction speed and temperature in the upper section of the SF 1 where the initial reduction of the iron oxide from Fe2O3 to Fe3O4 or FeO takes place. Process gas 8 discharged from the process gas compressor 7 is partially diverted to a process gas quench cooler 28 and then the quenched process gas 20 is injected into the upper section in the SF 1. The process gas quench cooler 28 lowers the temperature and improves the gas quality of the diverted process gas 27. Adjusting the flow rate of the quenched process gas 20 with a control valve 21, the temperature or gas quality of the top gas 4 or the reduction gas flowing through the iron oxide bed at the upper section in the SF 1 can be controlled. As an option, the length of the reduction zone of the SF 1 will be extended by 1˜3 m while that for the conventional SF is 9˜13 m depending on the diameter. The extension will secure the residence time required to maintain the productivity with the above cold gas injection. In some embodiments (Case B—FIG. 3), quenched reformed gas 30 is injected between the reduction gas 14 injection level and the top gas 4 offtake level to modulate the reduction speed and temperature in the upper section of the SF 1 where the initial reduction of the iron oxide from Fe2O3 to Fe3O4 or FeO takes place. Reformed gas 13 discharged from the reformer 12 is partially diverted to a reformed gas quench cooler 38 and then the quenched reformed gas 30 is injected into the upper section in the SF 1. The reformed gas quench cooler 38 lowers the temperature of the diverted reformed gas 37. Adjusting the flow rate of the quenched reformed gas 30 with a control valve 31, the temperature of the top gas 4 or the reduction gas flowing through the iron oxide bed at the upper section in the SF 1 can be controlled. As an option, the length of the reduction zone of the SF 1 will be extended by 1˜3 m while that for the conventional SF is 9˜13 m depending on the diameter. The extension will secure the residence time required to maintain the productivity with the above cold gas injection.

In some embodiments (Case C—FIG. 4), quenched mixed gas 40 is injected between the reduction gas 14 injection level and the top gas 4 offtake level to modulate the reduction speed and temperature in the upper section of the SF 1 where the initial reduction of the iron oxide from Fe2O3 to Fe3O4 or FeO takes place. Both cleaned process gas 8 discharged from the compressor 7 and hot reformed gas 13 discharged from the reformer 12 is partially diverted to a mixed gas quench cooler 48 and then the quenched mixed gas 40 is injected into the upper section in the SF 1. The mixed gas quench cooler 48 lowers the temperature and improves the gas quality of the gas mixture comprising the diverted process gas 27 and the diverted reformed gas 37. Adjusting the flow rate of the quenched mixed gas 40 with a control valve 41, the temperature or gas quality of the top gas 4 or the reduction gas flowing through the iron oxide bed at the upper section in the SF 1 can be controlled. As an option, the length of the reduction zone of the SF 1 will be extended by 1˜3 m while that for the conventional SF is 9˜13 m depending on the diameter. The extension will secure the residence time required to maintain the productivity with the above cold gas injection.

In some embodiments (Case D—FIG. 5), in the case of a H2 reduction plant without a reformer to produce H2 and CO from NG, cold process gas 50 is injected between the reduction gas 14 injection level and the top gas 4 offtake level to modulate the reduction speed and temperature in the upper section of SF 1 where the initial reduction of the iron oxide from Fe2O3 to Fe3O4 or FeO takes place. Cold cleaned process gas 8 discharged from the compressor 7 is partially diverted and then the diverted cold process gas 50 is injected into the upper section in the SF 1. The injection of the cold process gas 50 controls and lowers the temperature of the top gas 4 or the reduction gas 14 flowing through the iron oxide bed at the upper section in the SF 1. Adjusting the flow rate of the cold process gas 50 with a control valve 51, the temperature or gas quality of the top gas 4 or the reduction gas 14 flowing through the iron oxide bed at the upper section in the SF 1 can be controlled. As an option, the length of the reduction zone of the SF 1 will be extended by 1˜3 m while that for the conventional SF is 9˜13 m depending on the diameter. The extension will secure the residence time required to maintain the productivity with the above cold gas injection.

Thus, in some embodiments, gas 20, 30, 40, 50 is injected between the reduction gas 14 injection level and the top gas 4 offtake level to modulate the reduction speed and temperature in the upper section of the SF 1 where the initial reduction of the iron oxide from Fe2O3 to Fe3O4 or FeO takes place. This gas 20, 30, 40, 50 injected above the reduction gas 14 injection level in the SF 1 may be quenched process gas 20, quenched reformed gas 30, quenched mixed gas 40, and/or cold process gas 50.

In this respect, it will be readily apparent to those of ordinary skill in the art that components, features, and/or aspects of the various embodiments (plant, system, and/or method) may be included, omitted, or combined as desired in a given application, without limitation.

### BRIEF DESCRIPTION OF THE DRAWINGS

The present disclosure is illustrated and described with reference to the various drawings, in which any like reference numbers are used to denote like system/assembly components/method steps, as appropriate, and in which:

FIG. 1A is a schematic diagram illustrating a conventional DR system/method 101 with a NG reformer 12, where the reduction gas 14 coming from the reformer 12 is introduced into the SF 1 to counter the iron oxide material descending; the quenched process gas 29 from the process gas quench cooler 28 is mixed with the reformed gas 13 to temper the reduction gas 14 during the initial start-up; the reduction gas 14 is injected through the bustle port of the SF 1 and the spent gas after the iron oxide reduction is removed from the top of the SF 1 as the top gas 4;

FIG. 1B is a schematic diagram illustrating another conventional DR system/method 102 with a NG reformer 12, where the reduction gas 14 coming from the reformer 12 is introduced into the SF 1 to counter the iron oxide material descending; the quenched reformed gas 39 from the reformed gas quench cooler 38 is mixed with the reformed gas 13 to temper the reduction gas 14 during the initial start-up; the reduction gas 14 is injected through the bustle port of the SF 1 and the spent gas after the iron oxide reduction is removed from the top of the SF 1 as the top gas 4;

FIG. 1C is a schematic diagram illustrating another conventional DR system/method 103 with a H2 reduction, where the spent gas after the iron oxide reduction coming off the SF 1 is recycled and heated with a process gas heater 56 after adding make-up H2 16; the hot reduction gas 14 coming from the process gas heater 56 is introduced into the SF 1 to counter the iron oxide material descending; during the initial start-up, the temperature of the reduction gas 14 is adjusted by changing the heat input at the process gas heater 56;

FIG. 2 is a schematic diagram illustrating one embodiment of the present disclosure for the DR system (or plant) and method 200 (Case A) to mitigate the disintegration of the iron oxide during the reduction reaction in the SF 1, where the process gas 8 is partially quenched and thereafter injected to modulate the temperature or quality of the reduction gas 14 at the upper section in the SF 1 above the reduction gas 14 injection level; the flow rate of the quenched process gas 20 is adjusted to control the temperature or gas quality of the reduction gas flowing through the iron oxide bed at the upper section in the SF 1 and the top gas 4;

FIG. 3 is a schematic diagram illustrating another embodiment of the present disclosure for the DR system (or plant) and method 300 (Case B) to mitigate the disintegration of the iron oxide during the reduction reaction in the SF 1, where the reformed gas 13 is partially quenched and thereafter injected to modulate the reduction gas temperature and quality at the upper section in the SF 1 above the reduction gas 14 injection level; the flow rate of the quenched reformed gas 30 is adjusted to control the temperature or gas quality of the reduction gas flowing through the iron oxide bed at the upper section in the SF 1 and the top gas 4;

FIG. 4 is a schematic diagram illustrating a further embodiment of the present disclosure for the DR system (or plant) and method 400 (Case C) to mitigate the disintegration of the iron oxide during the reduction reaction in the SF 1, where both process gas 27 and reformed gas 37 are diverted and the mixed gas is sent to the mix gas quench cooler 48; the quenched mixed gas 40 is injected to modulate the reduction gas temperature and quality at the upper section in the SF 1 above the reduction gas 14 injection level; the flow rate of the process gas 27 is adjusted to control the gas quality of the quenched mixed gas 40; the flow rate of the quenched mixed gas 40 is adjusted to control the temperature or gas quality of the reduction gas flowing through the iron oxide bed at the upper section in the SF 1 and the top gas 4; and

FIG. 5 is a schematic diagram illustrating a still further embodiment of the present disclosure for the DR system (or plant) and method 500 (Case D) with H2 reduction to mitigate the disintegration of the iron oxide during the reduction reaction in the SF 1, where the cold process gas 50 is diverted and injected to modulate the reduction gas temperature and quality at the upper section in SF 1 above the reduction gas 14 injection level; the flow rate of the cold process gas 50 is adjusted to control the temperature or gas quality of the reduction gas flowing through the iron oxide bed at the upper section in the SF 1 and the top gas 4.

Again, it will be readily apparent to those of ordinary skill in the art that components, features, and/or aspects of the various embodiments (plant, system, and/or method) may be included, omitted, or combined as desired in a given application, without limitation.

### DETAILED DESCRIPTION

Again, in various embodiments, the present disclosure advantageously provides an improved DR system/method utilizing NG and/or H2 to mitigate iron oxide disintegration during the reduction reaction of the iron oxide in the SF. With the improved system/method, DR plants have more flexibility for the feedstocks to the SF, such as BF/low grade oxide pellets, lump ores, and CBQ, which tend to disintegrate during the reduction reaction in the SF, as compared with the DR grade oxide pellets commonly used in some DR plants. The ability to use BF/low grade oxide pellets facilitates the DR plant to secure the feedstock with lower cost. The replacement of the indurated pellets with the lump ore and/or CBQ enables the DR plants to reduce the life-cycle CO2 emissions.

Through a series of laboratory tests and observations of DR plant operations with various iron oxide feedstocks, it was found that the fines generation is significantly influenced by the initial reduction speed or temperature. The higher the initial reduction temperature is and/or the higher the initial reduction speed is, the more the iron oxide swells at the initial reduction stage or the reduction degree up to 10%˜ 30%. The swelling by the lattice structure changes from Fe2O3 to Fe3O4 or FeO happening at the upper section in the SF reduces the physical strength of the iron oxide, which enhances later disintegration through the movements in the moving bed. The reduced physical strength somewhat recovers later as the formation of the metallic iron progresses to sinter and shrink the material, but the strength recovery cannot make up the earlier strength reduction if the swelling exceeds the recovery. This is the case with lower grade oxide pellets containing less iron to make less recovery and lump ores having no slag or sintering bonding mechanism to prevent the excessive swelling. Furthermore, rapider and more significant swelling sometimes enhances the clustering of the material in the SF since the swelling helps the material to deform in a flat shape and increase the contact area under the burden load in the SF. The larger contact area for the deformed iron oxide pellets facilitates the material to stick together and make the clustering. Also, the fines generated from the disintegration could also help to make the clustering since the fines could bridge the iron oxide pellets.

Furthermore, CBQ bonded with the conventional binders cannot maintain the physical strength at the initial reduction temperature, typically 400˜700° C. in the SF. CBQ tends to disintegrate since the bonding strength by the binder is lost when it swells or before the sintering of metallic iron starts. In other words, the swelling with CBQ could be restrained if the temperature is maintained low enough for the binder to keep the bonding strength until the swelling declines or the metallic iron formation starts.

Therefore, the key point to mitigate the disintegration and the clustering due to the deformation of the iron oxide is to restrain the swelling or initial reduction speed of the iron oxide by modulating temperature and/or quality of the reduction gas flowing through the iron oxide bed in the upper section in the SF. In the prior art, however, all the reduction gas injected through the bustle port located in the lower section of the SF or below the reduction zone flows upward through the iron oxide bed. So, the reducing gas condition in the upper section in the SF is dominated by the reduction gas condition injected through the bustle port to meet the target productivity and product quality and cannot be flexibly changed. Furthermore, the rapid initial reduction of the iron oxide is enhanced within the relatively thinner bed layer below the stock line, due to the exothermic reaction from Fe2O3 to Fe3O4 and the efficient heat transfer from the large volume of reduction gas with the higher temperature to the iron oxide fed under the ambient temperature, where the reduction degree and the temperature of the iron oxide quickly ramps up. This helps to maximize the productivity with DR grade oxide pellets, but negatively works with lower grade oxide or CBQ making significant fines during the reduction process.

The present disclosure enables modulation (or moderation) of the temperature and/or quality of the reduction gas flowing through the iron oxide bed or flexibly changing the temperature and/or gas quality profile in the upper section in the SF by injecting the various cold gases above reduction (or bustle) gas injection, which modulates the speed of reduction and temperature rising to enlarge the initial reduction zone (i.e., the bed layer just below the stock line) in the upper portion in the SF. The cold gas is injected into the shaft furnace at the level between the reduction gas port and the top gas offtake. Preferably, the cold gas should be injected at the level higher than ⅔ of the reduction zone height, or higher than 6 m above bustle gas injection line in the reduction zone, where the reduction zone is defined as the burden section between the reduction gas port and the controlled feed stock line. The reduction zone length for the conventional SF is typically 9˜13 m depending on the diameter. The reduction reaction from Fe2O3 to Fe3O4 or FeO takes place at the upper section in the SF while the larger reduction area or longer residence time for the reduction reaction from FeO to Fe needs to be secured below the cold gas injection. Simultaneously, as an option, the length of the reduction zone of the SF 1 can be extended by 1˜3 m while that for the conventional SF is 9˜13 m depending on the diameter. The extension will offset the initial slower reduction or enlarge overall reduction zone, so that the productivity can be maintained.

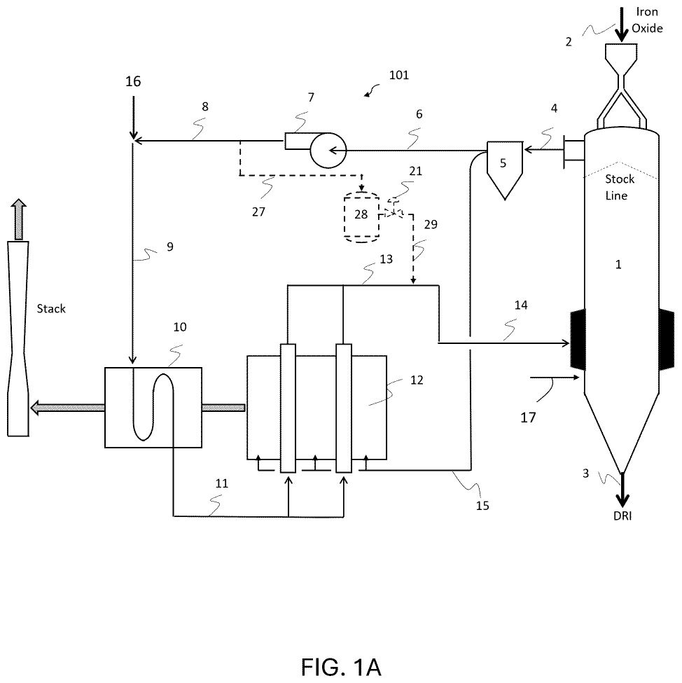

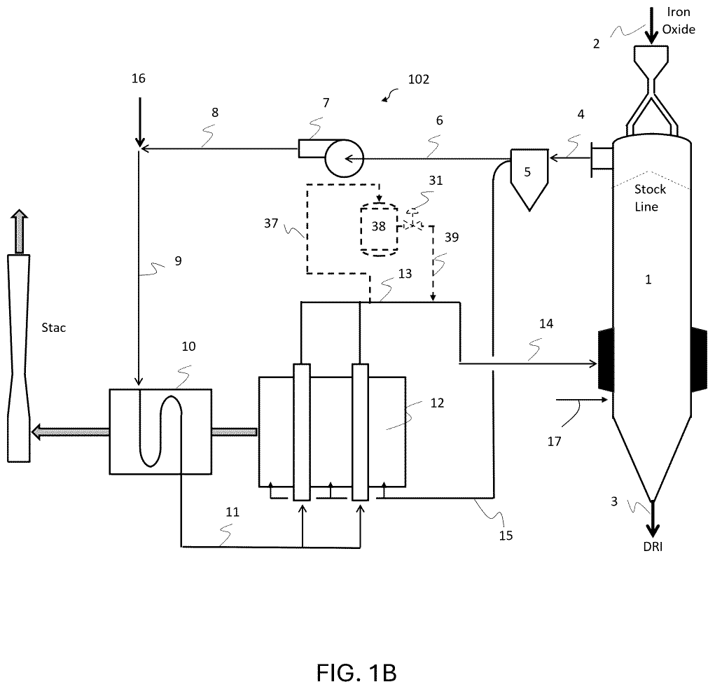

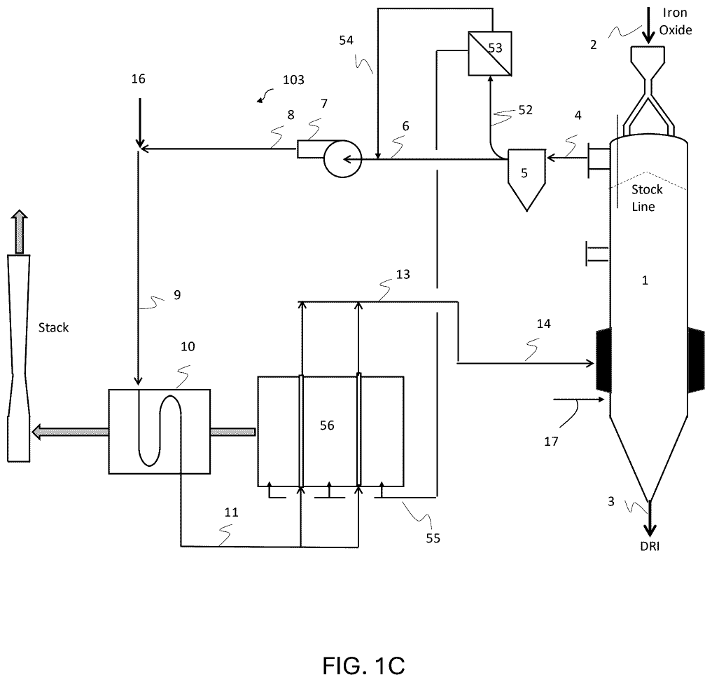

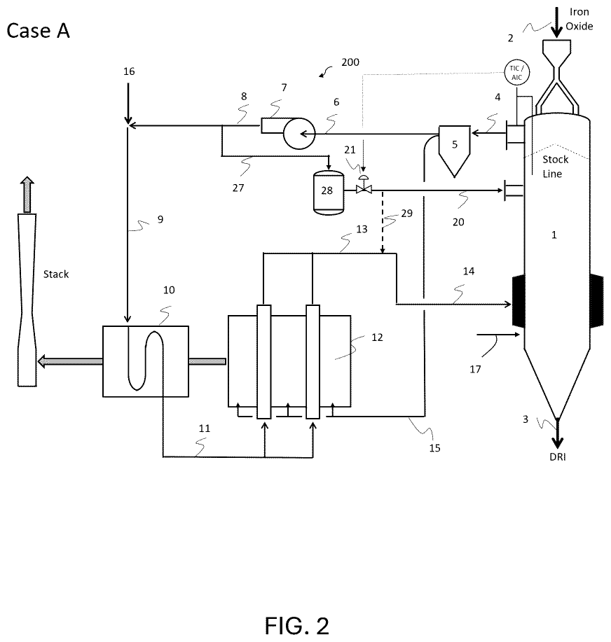

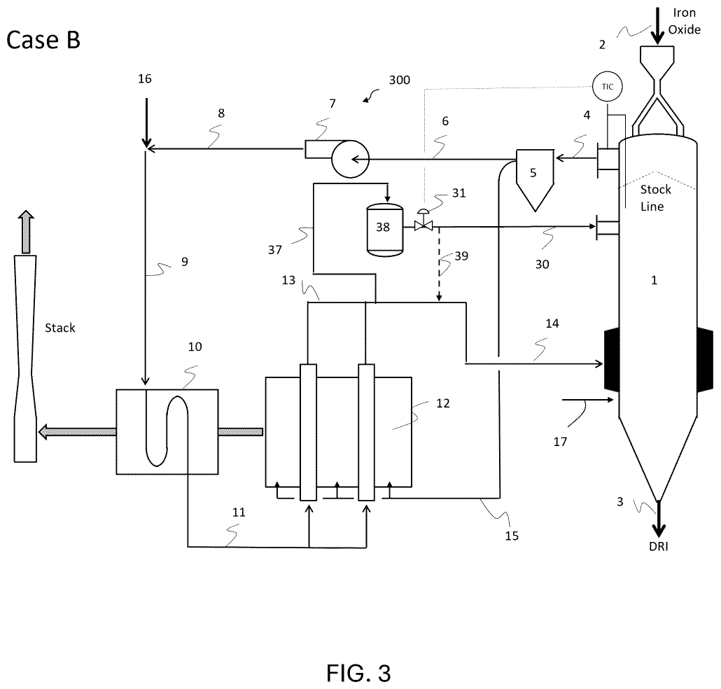

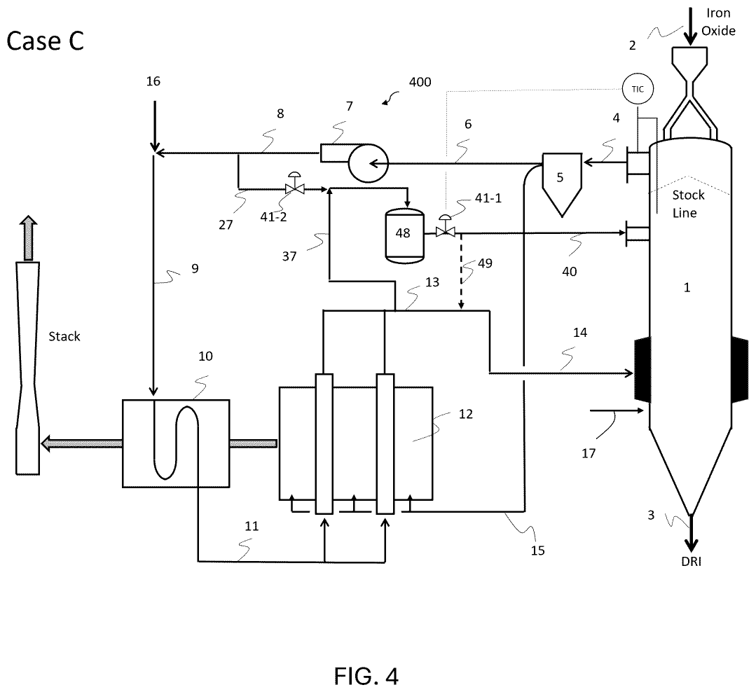

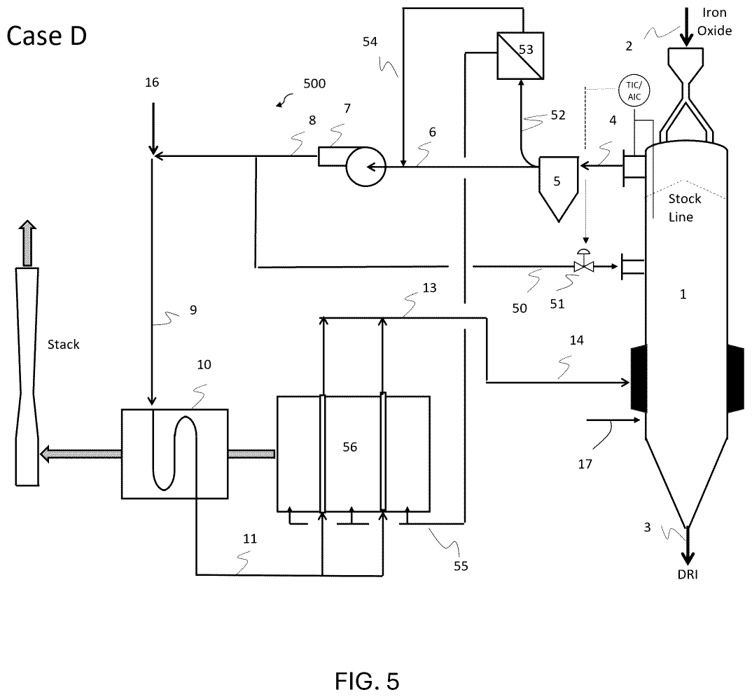

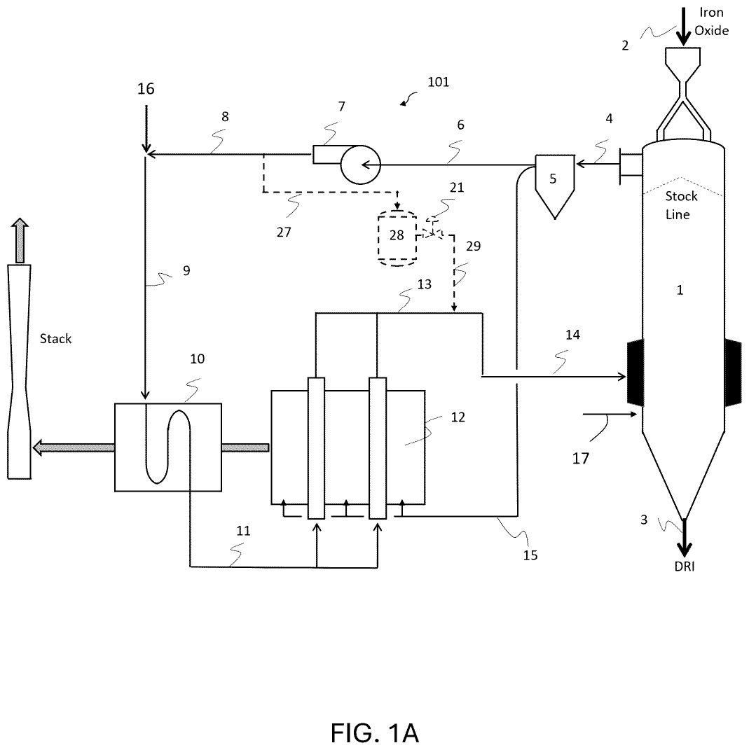

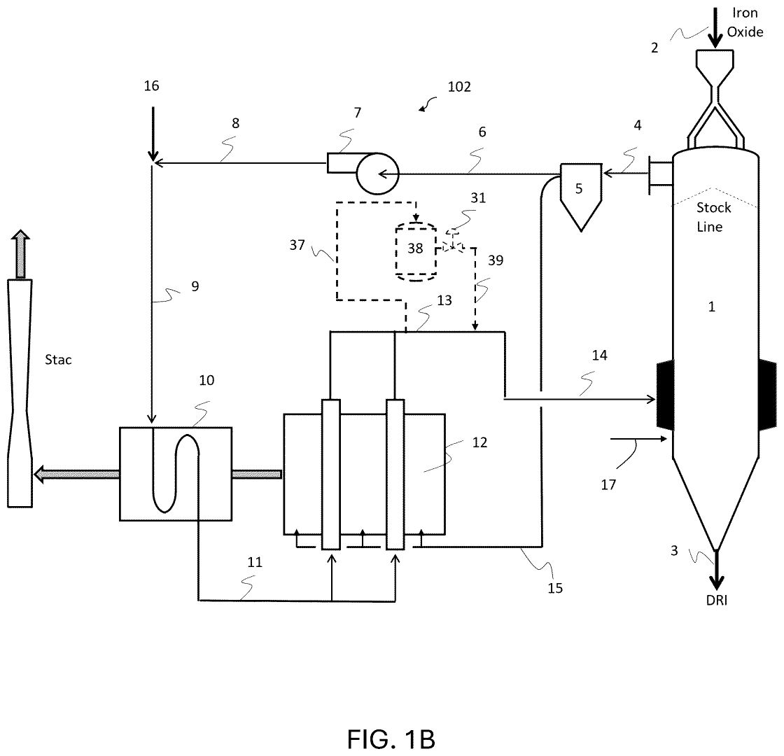

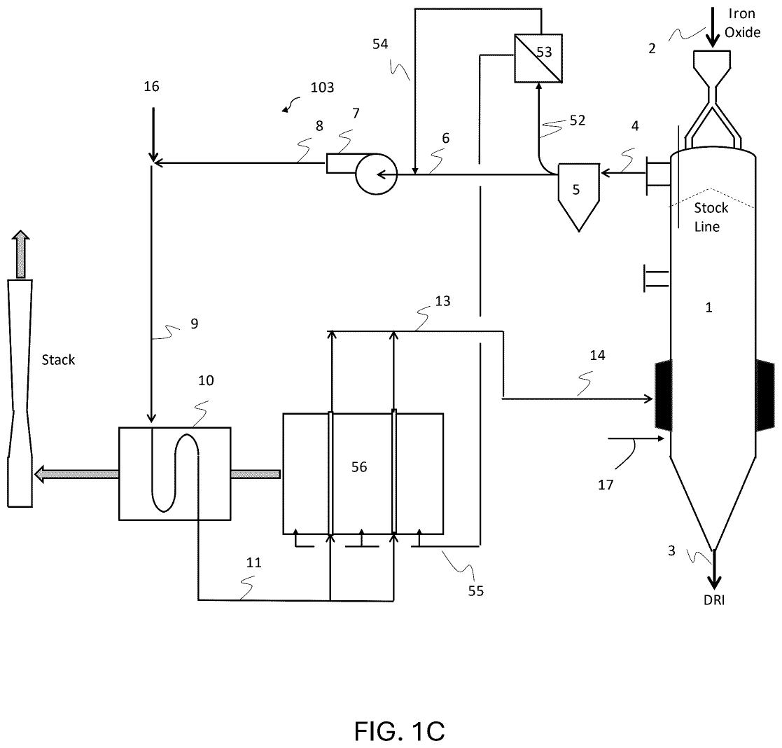

FIG. 1A shows a conventional DR system/method 101 utilizing NG and H2 which is exemplary described in U.S. Pat. No. 10,907,224B2. SF 1 receives the iron oxide 2 at the top and discharges the product DRI 3 from the bottom. The top gas 4 from the SF 1, which is the spent gas after the reduction of the iron oxide, contains the reaction product, such as H20 and CO2, as well as the unused reductant such as H2, CO, and CH4. After the top gas 4 is cooled and cleaned with a scrubber 5, most of the cleaned process gas 6 is recycled to the SF 1 through the reduction gas loop since it still contains H2 and CO, while what is called the top gas fuel 15 is partially removed to prevent the accumulation of inert N2 and CO2 from the reduction gas loop and combusted as reformer burner fuel. Make-up NG and H2 16 is added to the cleaned process gas 8 after the compressor 7 and the mixed gas 9 is preheated with a heat recovery system 10. Depending on H2 availability, H2 can be introduced together with NG as the reductant source to reduce CO2 emission. The preheated reformer feed gas 11 is fed to the reformer tubes containing a catalyst in the reformer 12, which enhance the reforming reaction of the methane derived from the NG to produce H2 and CO for the reductant of the iron oxide. The reformed gas 13 or the reduction gas 14 is then fed to the SF 1 to reduce the iron oxide 2. Hydrocarbon gas 17 is injected in the transition zone of the SF 1, which is located below the reduction gas 14 injection level, to carburize the DRI 3. Also, the cleaned process gas 8 after the compressor 7 is partially diverted to a process gas quench cooler 28 to lower the temperature and increase the gas quality (i.e., reduce the moisture content) of the quenched process gas 29, which is then mixed with the reformed gas 13 to temper the reduction gas 14. The cleaned process gas 8 still contains an amount of steam large enough for NG reforming in the reformer 12, although it is quenched with the scrubber 5. This is the reason the diverted process gas 8 is quenched with the process gas quench cooler 28, again. Note, the cleaned process gas 27 is sent to the process gas quench cooler 28 only at the initial start-up, when the temperature of the reduction gas 14 is carefully controlled and gradually increased from 700˜750° C. to 800˜1000° C. in starting to reduce the iron oxide 2 fully packed in the SF 1. No cleaned process gas 27 is sent to the quenched process gas cooler 28 during normal operation, which is the reason the system is drawn with the dotted line in FIG. 1A.

FIG. 1B shows another conventional DR system/method 102 utilizing NG and H2. The only difference from FIG. 1A is the use of quenched reformed gas 39 instead of the quenched process gas 29 in FIG. 1A to temper the reduction gas 14. The hot reformed gas 13 from the reformer 12 is partially diverted to a reformed gas quench cooler 38 to lower the temperature, which is then mixed with the reformed gas 13 to temper the reduction gas 14. Note, the hot reformed gas 37 is sent to the reformed gas quench cooler 38 only at the initial start-up, when the temperature of the reduction gas 14 is carefully controlled and gradually increased from 700˜750° C. to 800˜1000° C. in starting to reduce the iron oxide 2 fully packed in the SF 1. No hot reformed gas 37 is sent to the reformed gas quench cooler 38 during normal operation, which is the reason the system is drawn with the dotted line in FIG. 1B.

FIG. 1C shows another conventional DR system/method 103 utilizing H2, which is exemplary described in WO2022/169392A1. Unlike NG reduction cases, H2 reduction is performed in the DR SF with the reduction gas loop including a process gas heater 56 instead of the reformer 12 in FIG. 1A and FIG. 1B. The top gas 4 from the SF 1, which is the spent gas after the reduction of the iron oxide 2, contains the reaction product H20 as well as the unused reductant, mainly H2 and some CO or CH4 if any carbonaceous gas 17 is added to carburize the product DRI 3 in the SF 1. After the top gas 4 is cooled, cleaned, and dehumidified (i.e., remove H2O in the top gas 4) with the scrubber 5, most of the cleaned process gas 6 is recycled to the SF 1 through the reduction gas loop. The top gas fuel 52 is partially removed to prevent the accumulation of the inert N2 and CO2 (if the carbonaceous gas 17 is added) from the reduction gas loop. Thereafter, the top gas fuel 52 is processed with a gas separation unit 53, such as a pressure swing adsorption (PSA) system, to recover the unused H2 54, which is mixed with the cleaned process gas 6 and recycled back to the reduction gas loop. The tail gas 55 from the gas separation unit 53 contains mostly inert N2 with some combustibles such as H2, CO and CH4 requiring further processing. Therefore, the tail gas 55 could be sent to the process gas heater 56 and combusted with the burner fuel. Make-up H2 16 is added to the cleaned process gas 8 after the compressor 7 and the mixed gas 9 is preheated with the heat recovery system 10. The preheated reformer feed gas 11 is fed to the process gas heater 56 to heat the process gas 13 high enough to drive the iron oxide reduction in the SF 1. The heated process gas 13 or the hot reduction gas 14 is then fed to the SF 1 to reduce the iron oxide 2. During the initial start-up, the temperature of the reduction gas 14 is adjusted by changing the heat input at the process gas heater 56. The hydrocarbon gas 17 could be injected in the transition zone, which is located below the reduction gas 14 injection level in case the product DRI 3 needs to be carburized. The heat source of the process gas heater 56 could be electricity instead of fuel gas combustion. With the case, the tail gas 55 is vented or used by others as a fuel, depending on the case.

In these conventional systems/methods 101, 102, 103 the temperature and gas composition for the top gas 4 or those at the upper section in the SF 1 is inherently determined by the mass and energy transfer between the reduction gas 14 and the charged iron oxide 2. The reduction speed, temperature, and/or gas quality at the upper section in the SF 1 cannot be independently controlled other than by the reduction gas 14. For example, the initial reduction speed could be too high as the gas temperature and/or quality gets too high at the upper section in the SF 1 when much flow rate and high temperature for the reduction gas 14 is applied to bump up the production rate or metallization % for the product DRI 3.

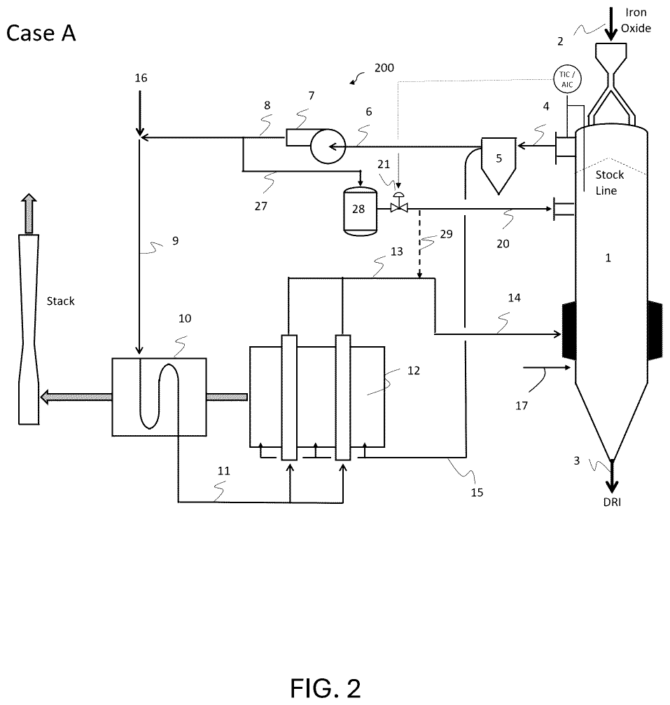

Referring now specifically to FIG. 2, in one embodiment, the key feature is to flexibly modulate (or moderate) the initial reduction speed, more specifically the temperature and gas quality flowing through the iron oxide bed at the upper section in the SF 1. This can be achieved by introducing the quenched process gas 20 to the upper section in the SF 1. The cleaned process gas 8 after the compressor 7 is partially diverted to the process gas quench cooler 28 to lower the temperature and increase the gas quality (i.e., reduce the moisture content) of the quenched process gas 20. Thereafter, the quenched process gas 20 is introduced between the level of feeding the reduction gas 14 and removing the top gas 4 in the SF 1, so that the temperature and gas quality of the reducing gas flowing through the iron oxide bed in the upper section in the SF 1 can be lowered by the temperature and gas quality difference between the quenched process gas 20 and the reducing gas flowing in the upper section in the SF 1. This modulates the initial reduction speed from Fe2O3 to Fe3O4 or FeO in the upper section in the SF 1 and mitigates the disintegration of the iron oxide 2 in the SF 1. Also, the temperature of the top gas 4 or the iron oxide bed at the upper section in the SF 1 can be controlled by adjusting the flow rate of the quenched process gas 20 introduced into SF 1. Monitoring the temperature of the top gas 4 or the iron oxide bed at the upper section in the SF 1, the flow rate can be adjusted with the control valve 21 to achieve the target temperature value, so that the reduction speed of the iron oxide 2 at the upper section in the SF 1 can be modulated under the varied operation condition. The quenched process gas 20 is preferably injected at the level higher than ⅔ of the reduction zone height or higher than 6 m above the level of feeding the reduction gas 14 in the SF 1. The reduction reaction from Fe2O3 to Fe3O4 or FeO takes place in the upper section in the SF while the larger reduction area or longer residence time for the reduction reaction from FeO to Fe needs to be secured. Also, as an option, the length of the reduction zone of the SF 1 will be extended by 1˜3 m while that for the conventional SF is typically 9˜13 m depending on the diameter. The extension will secure the residence time required to maintain the productivity with the quenched process gas 20 injection since the initial slower reduction may decrease the overall productivity in the SF 1 without the extension. Note, the process gas 27 is diverted to produce the quenched process gas 20 fed to SF 1 during the normal operation, but it is switched over to the quenched process gas 29 mixed with the reformed gas 13 to temper the reduction gas 14 during the initial start-up, as mentioned in the previous section, which is the reason the quenched process gas 29 is also drawn with the dotted line in FIG. 2. The diverted process gas 27 could be introduced between the level of feeding the reduction gas 14 and removing the top gas 4 in SF 1, without going through the process gas quench cooler 28. However, it is preferable to go through the process gas quench cooler 28 since the process gas 27 generally contains too much steam required for the NG reforming at the reformer 12.

One of the advantages of the present disclosure is to be able to control the reduction speed or the reduction condition at the upper section in the SF 1 independently from the reduction condition in the lower reduction section of the SF 1. The iron oxide reduction from FeO to Fe taking place in the lower reduction section of the SF 1 generally dominates the productivity in the SF 1 since the reduction requires highest reduction potential and temperature for the reduction gas 14, as compared with the prior reduction from Fe3O4 to FeO and from Fe2O3 to Fe3O4. The overall iron oxide reduction in the SF 1 is normally restricted by the reduction from FeO to Fe in the SF 1 with the counter-flow moving bed. Therefore, modulating the reduction potential of the spent up-flowing gas after the reduction from FeO to Fe is less critical to the productivity or product DRI quality than modulating the reduction potential of the bustle gas 14, although some performance reduction could be observed. This is the reason the injection level of the quenched process gas 20 should be preferably located at higher level of the reduction zone, as mentioned above. It would be sometimes more advantageous to be able to feed the inexpensive low-grade iron oxide 2 to mitigating the fines issue, tolerating the performance reduction. As an option, the length of the reduction zone of the SF 1 will be extended by 1˜3 m while that for the conventional SF is 9˜13 m depending on the diameter. The extension will secure the residence time required to maintain the productivity with the quenched process gas 20 injection since the initial slower reduction may decrease the overall productivity in the SF 1 without the extension.

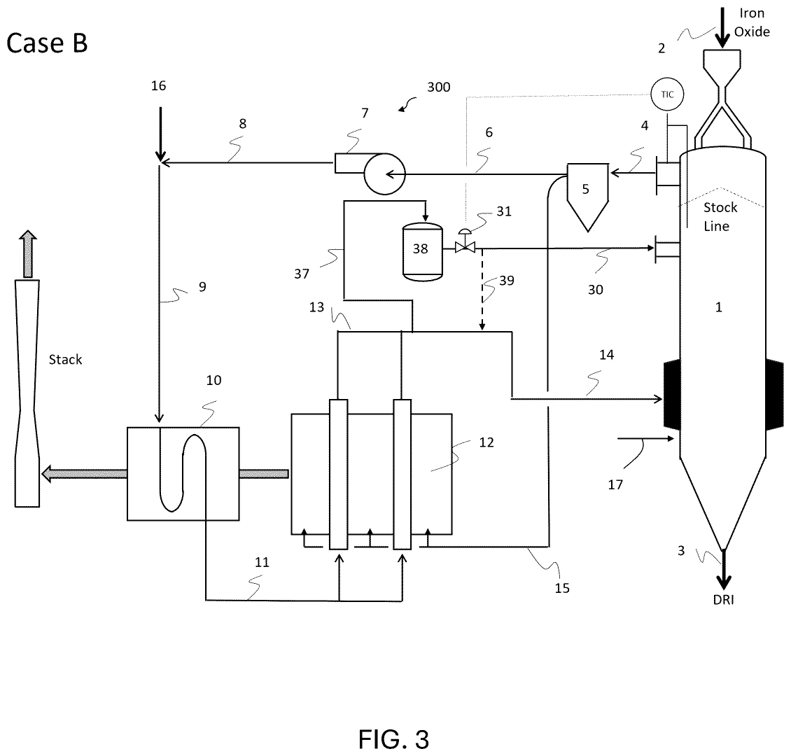

Referring now specifically to FIG. 3, in another embodiment, the key feature is to modulate (or moderate) the reduction speed more precisely at the upper section in the SF 1. The only difference from FIG. 2 is to use the quenched reformed gas 30 instead of the quenched process gas 20 in FIG. 2 to temper the reduction gas at the upper section in the SF 1 above the reduction gas 14 injection level. The hot reformed gas 13 from the reformer 12 is partially diverted to the reformed gas quench cooler 38 to lower the temperature of the quenched reformed gas 30. Thereafter, the quenched reformed gas 30 is introduced between the level of feeding the reduction gas 14 and removing the top gas 4 in the SF 1, so that the temperature and gas quality of the reducing gas flowing through the iron oxide bed in the upper section in the SF 1 can be lowered by the temperature difference between the quenched reformed gas 30 and the reducing gas flowing in the upper section in the SF 1. This modulates the initial reduction speed from Fe2O3 to Fe3O4 or FeO in the upper section in the SF 1 and mitigates the disintegration of the iron oxide 2 in the SF 1. Also, the temperature of the top gas 4 or the iron oxide bed at the upper section in the SF 1 can be controlled by adjusting the flow rate of the quenched reformed gas 30 introduced into the SF 1. Monitoring the temperature of the top gas 4 or the iron oxide bed at the upper section in the SF 1, the flow rate can be adjusted with the control valve 31 to achieve the target temperature value, so that the reduction speed of the iron oxide 2 at the upper section in the SF 1 can be modulated under the varied operation condition. The quenched reformed gas 30 is preferably injected at the level higher than ⅔ of the reduction zone height or higher than 6 m above the level of feeding the reduction gas 14 in the SF 1. The reduction reaction from Fe2O3 to Fe3O4 or FeO takes place in the upper section in the SF while the larger reduction area or longer residence time for the reduction reaction from FeO to Fe needs to be secured. As an option, the length of the reduction zone of the SF 1 will be extended by 1˜3 m while that for the conventional SF is 9˜13 m depending on the diameter. The extension will secure the residence time required to maintain the productivity with the quenched mixed gas 40 injection since the initial slower reduction may decrease the overall productivity in the SF 1 without the extension. Note, the reformed gas 37 is always diverted to produce the quenched reformed gas 30 fed to the SF 1 during the normal operation, but is switched over to the quenched process gas 39 mixed with the reformed gas 13 to temper the reduction gas 14 during the initial start-up, as mentioned in the former section, which is the reason the quenched process gas 39 is also drawn with the dotted line in FIG. 3.

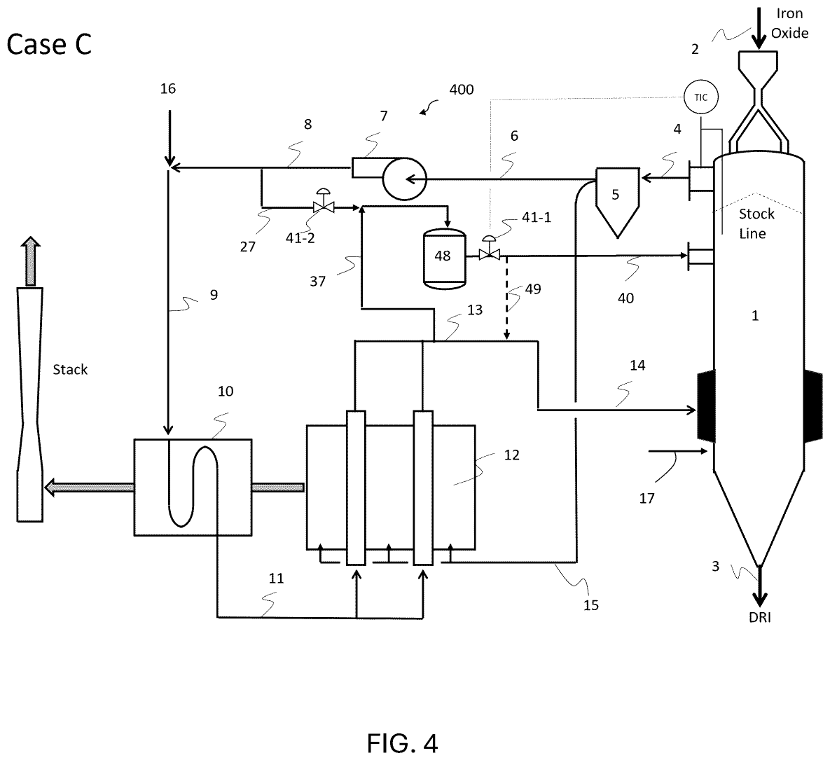

Referring now specifically to FIG. 4, in a further embodiment, the key feature is to modulate (or moderate) the reduction speed more precisely at the upper section in the SF 1. This is the combination of the previous options, where both cleaned process gas 8 after the compressor 7 and hot reformed gas 13 after reformer 12 is partially diverted to the mixed gas quench cooler 48 to lower the temperature and increase the gas quality (i.e., reduce the moisture content) of the quenched mixed gas 40. Thereafter, the quenched mixed gas 40 is introduced between the level of feeding the reduction gas 14 and removing the top gas 4 in the SF 1, so that the temperature and gas quality of the reducing gas flowing through the iron oxide bed in the upper section in the SF 1 can be adjusted by the temperature and gas quality difference between the quenched mixed gas 40 and the reducing gas flowing in the upper section in the SF 1. This modulates the initial reduction speed from Fe2O3 to Fe3O4 or FeO in the upper section in the SF 1 and mitigates the disintegration of the iron oxide 2 in the SF 1. The benefit of this option is that it enables adjusting the gas quality of the quenched gas introduced to the upper section in the SF 1 more precisely than the former two options shown in FIG. 2 or FIG. 3 by mixing lower quality process gas 27 and higher quality reformed gas 37. Also, the temperature of the top gas 4 or the iron oxide bed at the upper section in the SF 1 can be controlled by adjusting the flow rate of the quenched mixed gas 40 introduced into the SF 1. Monitoring the temperature of the top gas 4 or the iron oxide bed at the upper section in the SF 1, the flow rate can be adjusted with the control valve 41-1 to achieve the target temperature value, so that the reduction speed of the iron oxide 2 at the upper section in the SF 1 can be modulated under the varied operation condition. The gas quality of the quenched mixed gas 40 can be more precisely adjusted by changing the mix ratio of process gas 27 to reformed gas 37 with the control valve 41-2. The quenched mixed gas 40 is preferably injected at the level higher than ⅔ of the reduction zone height or higher than 6 m above the level of feeding the reduction gas 14 in the SF 1. The reduction reaction from Fe2O3 to Fe3O4 or FeO takes place in the upper section in the SF while the larger reduction area or longer residence time for the reduction reaction from FeO to Fe needs to be secured. As an option, the length of the reduction zone of the SF 1 will be extended by 1˜3 m while that for the conventional SF is 9˜13 m depending on the diameter. The extension will secure the residence time required to maintain the productivity with the quenched mixed gas 40 injection since the initial slower reduction may decrease the overall productivity in the SF 1 without the extension. Note, process gas 27 and reformed gas 37 are always diverted to produce the quenched mixed gas 40 fed to the SF 1 during the normal operation, but are switched over to the quenched process gas 49 mixed with the reformed gas 13 to temper the reduction gas 14 during the initial start-up, as mentioned in the former section, which is the reason the quenched process gas 49 is also drawn with the dotted line in FIG. 4.

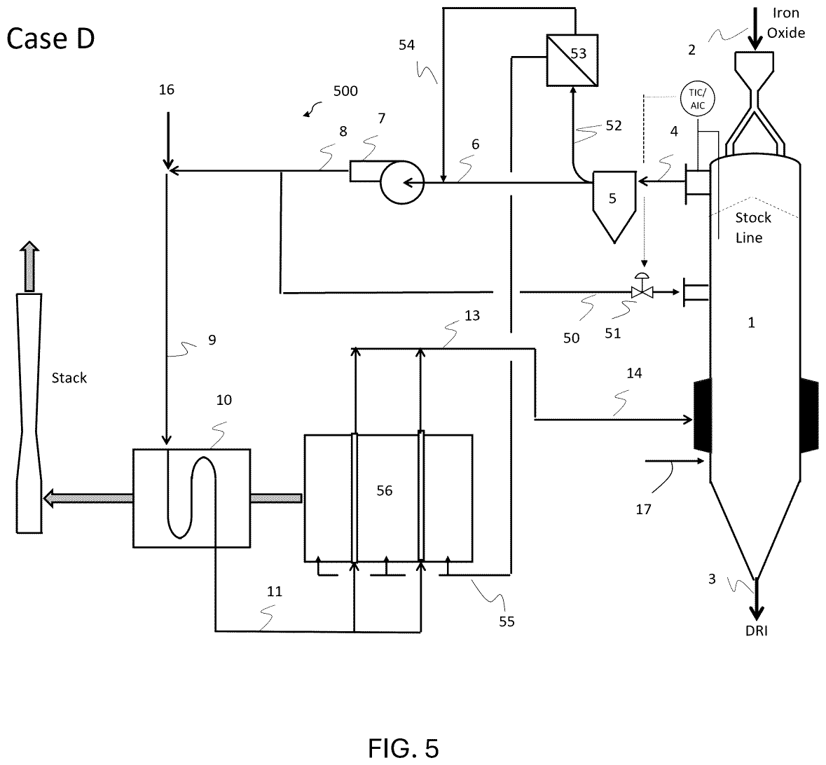

Referring now specifically to FIG. 5, in a still further embodiment, H2 reduction is performed with the process gas heater 56 instead of the reformer 12, where the injection of the cold process gas to the upper section of the SF shown in FIG. 2 is applied for the conventional H2 reduction case shown in FIG. 1C. The top gas 4 from the SF 1, which is the spent gas after the reduction of the iron oxide 2, contains the reaction product H2O as well as the unused reductant, mainly H2 and some CO or CH4 if any carbonaceous gas 17 is added to carburize the product DRI 3 in the SF 1. After the top gas 4 is cooled, cleaned, and dehumidified (i.e., remove H2O in the top gas 4) with the scrubber 5, most of the cleaned process gas 6 is recycled to the SF 1 through the reduction gas loop. The top gas fuel 52 is partially removed to prevent the accumulation of the inert N2 and CO2 (if the carbonaceous gas 17 is added) from the reduction gas loop. Thereafter, the top gas fuel 52 is processed with a gas separation unit 53, such as a pressure swing adsorption (PSA) system, to recover the unused H2 54, which is mixed with the cleaned process gas 6 and recycled back to the reduction gas loop. The tail gas 55 from the gas separation unit 53 is sent to the process gas heater 56 and combusted as the burner fuel. Make-up H2 16 is added to the cleaned process gas 8 after the compressor 7 and the mixed gas 9 is preheated with the heat recovery system 10. The preheated reformer feed gas 11 is fed to the process gas heater 56 to heat the process gas 13 high enough to drive the iron oxide reduction in the SF 1. The heated process gas 13 or the hot reduction gas 14 is then fed to the SF 1 to reduce the iron oxide 2. During the initial start-up, the temperature of the reduction gas 14 is adjusted by changing the heat input at the process gas heater 56. The hydrocarbon gas 17 could be injected in the transition zone, which is located below the reduction gas 14 injection level in case the product DRI 3 needs to be carburized. The heat source of the process gas heater 56 could be electricity instead of fuel gas combustion. With the case, the tail gas 55 is vented or used by others as a fuel, depending on the case.

The key feature is to flexibly modulate (or moderate) the initial reduction speed, more specifically the temperature, of the gas flowing through the iron oxide bed at the upper section in the SF 1. This can be achieved by introducing the cold process gas 50 to the upper section in the SF 1. The process gas 8 after the compressor 7 is partially diverted and introduced between the level of feeding the reduction gas 14 and removing the top gas 4 in the SF 1, so that the temperature of the reducing gas flowing through the iron oxide bed in the upper section in the SF 1 can be lowered by the temperature difference between the cold process gas 50 and the reducing gas flowing in the upper section in the SF 1. This modulates the initial reduction speed from Fe2O3 to Fe3O4 or FeO in the upper section in the SF 1 and mitigates the disintegration of the iron oxide 2 in the SF 1. Also, the temperature of the top gas 4 or the iron oxide bed at the upper section in the SF 1 can be controlled by adjusting the flow rate of the cold process gas 50 introduced into the SF 1. Monitoring the temperature of the top gas 4 or the iron oxide bed at the upper section in the SF 1, the flow rate can be adjusted with the control valve 51 to achieve the target temperature value, so that the reduction speed of the iron oxide at the upper section in the SF 1 can be modulated under the varied operation condition. The cold process gas 50 is preferably injected at the level higher than ⅔ of the reduction zone height or higher than 6 m above the level of feeding the reduction gas 14 in the SF 1. The reduction reaction from Fe2O3 to Fe3O4 or FeO takes place in the upper section in the SF while the larger reduction area or longer residence time for the reduction reaction from FeO to Fe needs to be secured. As an option, the length of the reduction zone of the SF 1 will be extended by 1˜3 m while that for the conventional SF is 9˜13 m depending on the diameter. The extension will secure the residence time required to maintain the productivity with the cold process gas 50 injection since the initial slower reduction may decrease the overall productivity in the SF 1 without the extension.

Again, in various embodiments, the present disclosure advantageously provides an improved DR system/method utilizing NG and/or H2 to mitigate iron oxide disintegration during the reduction reaction of the iron oxide in the SF. With the improved system/method, DR plants have more flexibility for the feedstocks to the SF, such as BF/low grade oxide pellets, lump ores, and CBQ, which tend to disintegrate during the reduction reaction in the SF, as compared with the DR grade oxide pellets commonly used in some DR plants. The ability to use BF/low grade oxide pellets facilitates the DR plant to secure the feedstock with lower cost. The replacement of the indurated pellets with the lump ore and/or CBQ enables the DR plants to reduce the life-cycle CO2 emissions.

The key point to mitigate the disintegration of the iron oxide is to restrain the swelling or initial reduction speed of the iron oxide by modulating temperature and/or quality of the reduction gas flowing through the iron oxide bed in the upper section in the SF. In the prior art, however, all the reduction gas injected through the bustle port located in the lower section of the SF or below the reduction zone flows upward through the iron oxide bed. So, the initial reducing speed or reducing gas condition in the upper section in the SF is dominated by the reduction gas condition injected through the bustle port to meet the target productivity and product quality and cannot be flexibly changed. Furthermore, the rapid initial reduction of the iron oxide is enhanced within the relatively thinner bed layer below the stock line, due to the exothermic reaction from Fe2O3 to Fe3O4 and the efficient heat transfer from the large volume of reduction gas to the iron oxide fed at the ambient temperature, where the reduction degree and temperature quickly ramps up. The rapid increase of the temperature and the reduction degree in the upper section of the SF helps to maximize the productivity with DR grade oxide pellets, but negatively works with lower grade oxide or CBQ making significant fines during the reduction process.

The present disclosure enables modulation (or moderation) of the temperature and/or quality of the reduction gas flowing through the iron oxide bed or flexibly changing the temperature and/or gas quality profile in the upper section in the SF by injecting the various cold gases above reduction (or bustle) gas injection, which modulates the speed of reduction and temperature rising to enlarge the initial reduction zone (i.e., the bed layer just below the stock line) in the upper portion in the SF. The various cold process gases are preferably injected at the level higher than ⅔ of the reduction zone height or higher than 6 m above the level of feeding the reduction gas 14 in the SF 1. The reduction reaction from Fe2O3 to Fe3O4 or FeO takes place in the upper section in the SF while the larger reduction area or longer residence time for the reduction reaction from FeO to Fe needs to be secured. As an option, the length of the reduction zone will be extended by 1˜3 m for the SF with the various cold gas injections while that for the conventional SF is 9˜13 m depending on the diameter. This will offset the initial slower reduction or enlarged overall reduction zone, so that the productivity can be maintained.

Although the present disclosure is illustrated and described with reference to particular embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes. Moreover, all features, elements, and embodiments described herein may be used in any combination(s).

What is claimed is:

1. A direct reduction method comprising:
injecting a reduction gas into a shaft furnace at a reduction gas injection level to reduce iron oxide to direct reduced iron within the shaft furnace;
removing a top gas from a top gas offtake located at a level above the reduction gas injection level; and
injecting a gas into the shaft furnace at a gas injection level above the reduction gas injection level and below the top gas offtake level to moderate a reduction speed and temperature in an upper portion of the shaft furnace.

2. The direct reduction method of claim 1, wherein the gas comprises one or more of a quenched process gas, a quenched reformed gas, a quenched mixed gas, and a cold process gas.

3. The direct reduction method of claim 2, wherein the gas injection level is higher than ⅔ of a reduction zone height or higher than 6 m above the reduction gas injection level, wherein a reduction zone is defined as a burden zone between the reduction gas injection level and a controlled feed stock line in the shaft furnace.

4. The direct reduction method of claim 2, wherein a flow of the gas to the shaft furnace is controlled via a control valve.

5. The direct reduction method of claim 2, wherein the quenched process gas comprises a process gas received from a process gas compressor and quenched in a process gas quench cooler, wherein the process gas comprises the top gas that is cooled and cleaned with a scrubber.

6. The direct reduction method of claim 2, wherein the quenched reformed gas comprises a reformed gas received from a reformer and quenched in a reformed gas quench cooler.

7. The direct reduction method of claim 6, wherein the reformed gas comprises reformer feed gas that is preheated with a heat recovery system, which comprises a process gas to which make-up natural gas is added, which comprises a process gas that is compressed in a process gas compressor, which comprises the top gas that is cooled and cleaned with a scrubber.

8. The direct reduction method of claim 2, wherein the quenched mixed gas comprises a process gas received from a process gas compressor and a reformed gas received from a reformer, wherein the process gas and the reformed gas are both quenched in a mixed gas quench cooler.

9. The direct reduction method of claim 8, wherein a ratio of the process gas and the reformed gas in the quenched mixed gas is controlled via a control valve.

10. The direct reduction method of claim 8, wherein the process gas comprises the top gas that is cooled and cleaned with a scrubber.

11. The direct reduction method of claim 8, wherein the reformed gas comprises reformer feed gas that is preheated with a heat recovery system, which comprises a process gas to which make-up natural gas is added, which comprises a process gas that is compressed in a process gas compressor, which comprises the top gas that is cooled and cleaned with a scrubber.

12. The direct reduction method of claim 2, wherein the cold process gas comprises a process gas received from a process gas compressor when the direct reduction method utilizes hydrogen without reformer, wherein the process gas comprises the top gas that is cooled and cleaned with a scrubber.

13. The direct reduction method of claim 12, wherein the process gas further comprises unused hydrogen that is recovered from the top gas using a gas separation unit.

14. The direct reduction method of claim 1, wherein a length of a reduction zone is extended by 1˜3 m from a conventional length of the reduction zone from 9˜13 m, wherein the reduction zone is defined as a burden zone between the reduction gas injection level and a controlled feed stock line in the shaft furnace to achieve a residence time required to maintain a predetermined productivity of reducing the iron oxide to the direct reduced iron within the shaft furnace with the gas injection.

15. A direct reduction system comprising:
a shaft furnace comprising:
a reduction gas injection level at which a reduction gas is injected into the shaft furnace to reduce iron oxide to direct reduced iron within the shaft furnace;
a top gas offtake level above the reduction gas injection level from which a top gas is removed from the shaft furnace; and
a gas injection level above the reduction gas injection level and below the top gas offtake level at which a gas is injected into the shaft furnace to moderate a reduction speed and temperature in an upper portion of the shaft furnace.

16. The direct reduction system of claim 15, wherein the gas comprises one or more of a quenched process gas, a quenched reformed gas, a quenched mixed gas, and a cold process gas.

17. The direct reduction system of claim 16, wherein the gas injection level is higher than ⅔ of a reduction zone height or higher than 6 m above the reduction gas injection level, wherein a reduction zone is defined as a burden zone between the reduction gas injection level and a controlled feed stock line in the shaft furnace.

18. The direct reduction system of claim 16, further comprising a control valve for controlling a flow of the gas to the shaft furnace.

19. The direct reduction system of claim 16, wherein:
the quenched process gas comprises a process gas received from a process gas compressor and quenched in a process gas quench cooler, and the process gas comprises the top gas that is cooled and cleaned with a scrubber;
the quenched reformed gas comprises a reformed gas received from a reformer and quenched in a reformed gas quench cooler, and the reformed gas comprises reformer feed gas that is preheated with a heat recovery system, which comprises a process gas to which make-up natural gas is added, which comprises a process gas that is compressed in a process gas compressor, which comprises the top gas that is cooled and cleaned with a scrubber;
the quenched mixed gas comprises a process gas received from a process gas compressor and a reformed gas received from a reformer, wherein the process gas and the reformed gas are both quenched in a mixed gas quench cooler, a ratio of the process gas and the reformed gas in the quenched mixed gas is controlled via a control valve, the process gas comprises the top gas that is cooled and cleaned with a scrubber, and the reformed gas comprises reformer feed gas that is preheated with a heat recovery system, which comprises a process gas to which make-up natural gas is added, which comprises a process gas that is compressed in a process gas compressor, which comprises the top gas that is cooled and cleaned with a scrubber; and
the cold process gas comprises a process gas received from a process gas compressor when the direct reduction system utilizes hydrogen and no reformer, the process gas comprises the top gas that is cooled and cleaned with a scrubber, and the process gas further comprises unused hydrogen that is recovered from the top gas using a gas separation unit.

20. The direct reduction system of claim 15, wherein a length of a reduction zone is extended by 1˜3 m from a conventional length of the reduction zone from 9˜13 m, where the reduction zone is defined as a burden zone between the reduction gas injection level and a controlled feed stock line in the shaft furnace to achieve a residence time required to maintain a predetermined productivity of reducing the iron oxide to the direct reduced iron within the shaft furnace with the gas injection.
